(19) United States
(12) Patent Application Publication
(10) Pub. No.: US 2017/0295323 A1
(43) Pub. Date: Oct. 12, 2017

(54) SUB-SURFACE EMR TRANSMISSION FOR SCANNING PRODUCE

(71) Applicant: EMPIRE TECHNOLOGY DEVELOPMENT LLC, Wilmington, DE (US)

(72) Inventors: Benjamin William MILLAR, Redfern (AU); George Charles PEPPOU, Ashfield (AU)

(73) Assignee: EMPIRE TECHNOLOGY DEVELOPMENT LLC, Wilmington, DE (US)

(21) Appl. No.: 15/094,973

(22) Filed: Apr. 8, 2016

(51) Int. Cl. H04N 5/232; G02B 27/30; B07C 5/34; G02B 26/12; H04N 7/18; H04N 5/225; G06T 7/00; G02B 27/28

(52) U.S. Cl. CPC H04N 5/23296; G06T 7/0008; G02B 27/30; G02B 27/281; G02B 26/12; H04N 7/181; H04N 5/2256; B07C 5/3416; G06T 2207/30128; B07C 2501/009

(57) ABSTRACT

The embodiments disclosed herein provide devices, systems and methods for produce scanning, wherein the produce scanning devices comprise a light source, a produce stage, and a detector array positioned on the opposing side of the produce stage to the light source, wherein the light source and the detector array form a scanning assembly, and the transmitted light from the light source can reach the detector array. In some embodiments, the light source is a collimated light source, and only the directly transmitted light may reach the detector array. In some embodiments, a collimating filter is positioned between the produce stage and the detector array.

### BACKGROUND

Susceptible produce (e.g., fruits or vegetables) in various pest (e.g., fruit-fly) inhabited regions may not be able to be exported internationally and often even within domestic regions due to the risk of infestation, and an inability to provide a pest free guarantee on an item-by-item basis. The pest infestation of produce has the potential to cause the collapse and/or massive downscaling of a number of regions' produce sectors, and the quarantine destruction of produce.

A method to rapidly and cost effectively determine the presence and stage of pest infestation and selection of pest-free produce on an item-by-item basis would allow the continuation of produce growing and exporting operations in regions known to be inhabited by destructive pests, and reduce the need for zero tolerance destruction of entire shipments due to low level pest infestation.

Current rapid methods of optical produce assessment and pest detection rely on human judgement or external surface scanning alone. Human inspection is slow, expensive and is subject to a high rate of errors. Further, surface interrogation is incapable of subsurface detection of pests, where the majority of eggs and larvae for major pests resides. Therefore, it would be advantageous to have improved methods of pest detection that can detect pests below the surface of produce.

### SUMMARY

In one embodiment, a system for scanning produce can include a scanning assembly that has at least one electromagnetic radiation emitter, and a detector array of detector elements positioned so as to be operably coupled with the at least one electromagnetic radiation emitter so as to receive the emitted electromagnetic radiation. The system can also include a produce stage that can hold produce before, during and/or after scanning with the scanning assembly. The system can include a rotational mechanism attached to at least one of the scanning assembly or produce stage such that the scanning assembly and rotational stage are rotatable with respect to each other. That is, one of or both of the scanning assembly or produce stage rotates. The system can also include a first electromagnetic radiation polarizer operably coupled with the at least one electromagnetic radiation emitter so as to polarize the emitted electromagnetic radiation. The system can also include a first electromagnetic radiation collimator operably coupled with the at least one electromagnetic radiation emitter so as to collimate the emitted electromagnetic radiation.

In one embodiment, the system can include a second electromagnetic radiation polarizer operably coupled with the at least one electromagnetic radiation emitter and detector array. The first and second electromagnetic radiation polarizers can be aligned along an electromagnetic radiation beam. The first and second electromagnetic radiation polarizers can have the same polarization orientation. The first electromagnetic radiation polarizer is positioned between the at least one electromagnetic radiation emitter and the produce stage, and the second electromagnetic radiation polarizer is positioned between the produce stage and the detector array so as to polarize the electromagnetic radiation before being received into the detector array.

In one embodiment, a second electromagnetic radiation collimator is operably coupled with the at least one electromagnetic radiation emitter and detector array. The first and second electromagnetic radiation collimators can be aligned along an electromagnetic radiation beam. The first electromagnetic radiation collimator is between the at least one electromagnetic radiation emitter and produce stage, and the second electromagnetic radiation collimator is between the produce stage and the detector array so as to collimate the electromagnetic radiation before being received into the detector array.

In one embodiment, at least one of the first electromagnetic radiation collimator or second electromagnetic radiation collimator comprises an array of collimating tunnels. In one aspect, each detector element of the detector array is aligned in the electromagnetic radiation beam with a separate collimating tunnel of the array of collimating tunnels of the second electromagnetic radiation collimator.

In one embodiment, the electromagnetic radiation emitter has an emission wavelength band selected from the group consisting of about 400 to 550 nm, about 600 to 900 nm, about 8000 nm (e.g., 37 THz), or about 3000 microns (e.g., 100 GHz) to 374,740 microns (e.g., 800 GHz). At least one electromagnetic radiation emitter is selected from the group consisting of a laser array, a scanned laser array, an LED array, a THz emitter array, a sub-THz emitter array, a far-infrared emitter array, a focused broadband source having a plurality of emitters of different wavelengths, and a combination thereof. The emitters can be selected based on the desired wavelength band, which can be selected based on the type of item, such as produce, that is being scanned. In one aspect, the detector array includes a charge coupled device (CCD) array or THz tuned silicon CMOS antenna array. The detector can be configured to detect the desired wavelength band.

In one embodiment, the at least one electromagnetic radiation emitter includes at least one light emitter. The light can be emitted by any type of emitter, from lasers to broadband light sources (e.g., light bulbs or white light LEDs). The system can include a single collimating lens optically coupled with the light emitter and detector array. Alternatively, a collimating lens array can be optically coupled with a light emitter array and detector array.

In one embodiment, the system can include a rotating polygon mirror member that has a plurality of mirror faces that optically couple the at least one electromagnetic radiation emitter when rotated and aligned. Each mirror face can also be optically aligned with the detector array by reflecting electromagnetic radiation from the at least one electromagnetic radiation emitter to the detector array.

In one embodiment, an imaging controller can be operably coupled with the at least one electromagnetic radiation emitter and/or detector array to provide control thereof for image acquisition.

In one embodiment, a conveyor system can be associated with the produce stage so as to be capable of conveying produce to the produce stage. The system can include a conveyor controller (e.g., computing system or module thereof) operably coupled with the conveyor so as to be capable of controlling the conveying of produce to and/or from the produce stage.

In one embodiment, the system can include a produce sorter associated with the conveyor so as to be capable of sorting the produce on the conveyer. The system can include a sorter controller (e.g., computing system or module thereof) operably coupled with the produce sorter as to be capable of controlling the sorting of the produce.

In one embodiment, the system can include an image processor module configured for processing images acquired from the detector array.

In one embodiment, a method for scanning produce is provided with the scanning systems described herein. The scanning method can include transmitting electromagnetic radiation through at least a portion of a produce or other item using at least one electromagnetic radiation emitter, and then detecting the electromagnetic radiation transmitted through the at least a portion of the produce using a detector array that is operably coupled with the at least one electromagnetic radiation emitter. During the scanning, the method can include rotating the produce relative to the detector array, and imaging the produce or other item during the rotating to obtain a series of produce images from different rotational positions. The method can also include analyzing the series of detector images of the produce to determine whether a pest is in the produce. The method may also include sorting the produce based on whether or not a pest is in the produce.

In one embodiment, a method for scanning produce can be performed with the systems described herein. The scanning method can include transmitting electromagnetic radiation through at least a portion of a produce using at least one electromagnetic radiation emitter, and detecting the electromagnetic radiation transmitted through the at least a portion of the produce using a detector array that is operably coupled with the at least one electromagnetic radiation emitter. During the scanning, the method can include rotating a scanning assembly relative to the produce, the scanning assembly having the at least one electromagnetic radiation emitter and detector array, and imaging the produce during the rotating to obtain a series of produce images from different rotational positions.

The method can also include analyzing the series of detector images of the produce to determine whether a pest is in the produce. The method may also include sorting the produce based on whether or not a pest is in the produce.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates an embodiment of a system for scanning items.

FIG. 1A shows a representation of an image obtained by the system of FIG. 1.

FIG. 1B shows a side view of a rotational mechanism that is configured to rotate the item.

FIG. 1C shows an image having the core with no EMR, ring of attenuated EMR, and ring of fully transmitted EMR.

FIG. 1D shows a series of images of the item during rotation with the rotational mechanism of FIG. 1B.

FIG. 2 illustrates another embodiment of a system for scanning items.

FIG. 3 illustrates another embodiment of a system for scanning items.

FIG. 4 illustrates another embodiment of a system for scanning items.

FIG. 5 illustrates an embodiment of an EMR conditioner that is configured as a collimating filter that filters EMR that is not directly transmitted through the item.

FIG. 5A shows an image of an embodiment of a collimating filter that has an array of conduits extending therethrough.

FIG. 6 shows an example computing device that is arranged to perform the computing methods to operate the scanning systems to perform the scanning methods.

FIG. 7 shows an embodiment of a scanning and sorting system.

FIGS. 8 and 8A show a scanning system that has the scanning assembly configured to be rotatable.

The elements in the figures are arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the embodiments of the technology disclosed herein provide systems and methods for rapid and efficient interrogation of produce to determine the absence or presence of a pest infestation both on the surface and beneath the surface of a produce or other item. The systems and methods allow a high level of confidence in determining infestation presence in produce at a low cost and high detection rate. The systems and methods may be utilized during harvesting of the produce, and may be utilized during post-harvest packaging of the produce. As such, reference herein to a “produce” or “cultivated food” is meant to describe a fruit, vegetable, nut, or seed, or any other edible plant-based food that is grown and cultivated. A “harvested food” or “harvested cultivated food” refers to a cultivated food that has been harvested. Accordingly, the systems and methods may also be used for enhancing the detection of pests in any cultivated food by the mechanisms described herein, without limitation. The systems and methods can be utilized with any type of produce, such as cultivated foods, or any type of item that allows some transmission of electromagnetic radiation (EMR) through the item. Various materials can have the radiolucency and absorption that allow the systems to be used for subsurface imaging.

Some embodiments disclosed herein provide devices for produce scanning with electromagnetic radiation. A scanning device can include: an electromagnetic radiation emitter (e.g., light source), a produce stage configured to hold produce, and a detector array that can detect electromagnetic radiation that has passed through the produce. The detector array can be positioned on the opposing side of the produce stage from the electromagnetic radiation (i.e., “EMR”) emitter. The EMR emitter and the detector array can form a scanning assembly. In one example, transmitted light from the light source that passes through at least a portion of the produce can reach the detector array. The detector array can then facilitate image acquisition to obtain images of the produce.

In one embodiment, a polarized and collimated EMR beam is projected at an individual piece of produce. Subsurface pests are detected by variance of transmission intensity through produce tissue. As most wavelengths are absorbed strongly by the produce tissue and are unable to penetrate the entire thickness of an intact produce, transmission is only possible through a shallow secant path at the edge of the produce where the thickness is low. Appropriate EMR wavelengths are capable of passing through sufficient produce tissue distances to allow the secant path to reach a maximum depth of at least 3 mm beneath the produce surface. This depth of EMR penetration is adequate to detect many pests, such as fruit fly eggs and larvae. The depth of the EMR penetration also forms EMR transmission rings that are shaped by the produce shape, which transmission rings are detected by a detector array. A highly directional and identically polarized detector array (e.g., filtering all scattered light) can be positioned on the opposing side of the produce relative to the EMR emitter.

The produce can be rotated through 180° on an axis substantially perpendicular to the projected EMR beam. The detector array acquires a series of images of the transmission rings during this rotation (e.g., while actively rotating or during brief stops in rotation), resulting in a full interrogation of the region down to at least about 3 mm deep across the entire surface of the produce. Varying produce sizes can be accounted for by using a distributed light source with a diameter greater than the maximum cross-sectional area of the maximum expected produce diameter. Elongated produce (e.g., eggplant, cucumbers, squash, bananas, etc.) may also be examined with systems that can direct the EMR beam along a longitudinal length and by rotation of the elongated produce around a longitudinal axis. This projection and rotation technique allows the detector array to be used on substantially any shape of produce. Any item of produce that is primarily convex or has a circular cross-sectional profile, even if spherical or elongate, can be scanned using the systems and methods described herein.

Shallow penetration of produce with EMR allows for rapid and simple interrogation of the interior regions of the produce. The EMR penetration is reduced in produce tissue due to high absorbance and scattering of most of the wavelengths capable of providing sufficiently high resolution. The result is a limited effective depth of EMR transmission that is less than the total thickness of the produce. However, pest infestation typically occurs within the tissue immediately beneath the surface of the produce to a depth of approximately 3 mm. A projected EMR beam travels only a short shallow secant path through the edge of produce to reach this depth, where EMR beams directed at the middle of the produce are absorbed and fully attenuated. However, the variation of direct transmission around the produce or through the shallow secant path compared to the substantially blocked transmission in the middle of the produce results in transmission rings of the shallow secant path that show the presence or absence of pests. Any pests in the transmission rings will further attenuate the transmission and will be detected by the detector array as dark spots in the EMR ring.

Directly transmitted light (e.g., the small portion of the original beam not subjected to scattering) allows an image of the subsurface region and any areas within it that possess anomalous absorption, reflective, or refractive properties, examples of which can include eggs, larvae and structural damage therefrom. The majority of the projected light is scattered in addition to being absorbed. The directional detector array and polarization matching eliminates this scattered light from imaging, greatly reducing noise, and providing accurate usable images at a high frame-rate. Image recognition software is used to determine the produce boundary region, recognizable by partial transmission signal strength. Anomalies within this region are similarly identified by reduction in transmission signal strength.

Different scattering and absorbance characteristics of eggs, larvae and damage produce recognizable shadows. Significant divergence in the dielectric properties of fresh fruit and insect tissue are known, providing difference in absorbance characteristics at frequencies shorter than 1 GHz. Varied absorbance and reflectivity properties between insects and fruit tissue are also established for visible light and UV.

During produce scanning, collimated EMR is projected at a piece of produce, a portion of which is transmitted directly through thin section secant paths of up to 3 mm beneath the surface of the produce, forming an imaged ring of the edge of the produce piece. The produce piece is rotated on the axis shown, to generate similar images for the entire sub-surface. An image from scanning can show a ring of direct transmission of light through the low travel distance of a shallow secant path compared to total absorbance by thicker portions of the produce body. The scanning image can show increased attenuation in the directly transmitted light, which can be caused by a number of factors. Commonly, the EMR is further inhibited and absorbed as it passes through an insect egg or larva in produce.

In most scanning images, the produce piece is at the center, and there is a gradual transmission drop off from the edge of the produce inwards, as produce thickness increases. Insect eggs and larva can be visible within this partial transmission region, which allows for non-invasive sub-surface pest detection. Also, during scanning, a series of exemplary detector images can be obtained up through 90° (e.g., half total scanning rotation) or through 180° or through 360° or any degrees corresponding to the produce position, demonstrating complete coverage of the subsurface region of the produce. The light source emits light across the entirety of the produce scanning area including the portion that is absorbed entirely by the produce tissue. This is to ensure complete coverage of the produce regardless of shape and size.

The scanning system can include a defocused laser diode array generating divergent laser beams which are allowed to spread before being re-collimated by a collimating lens array to provide total coverage of the produce being scanned. Another embodiment of a scanning system can include a convergent angled laser diode array which includes an array of collimated laser diodes angled for beam convergence. The convergent angled laser diode array can be designed to produce the same total coverage effect, but at higher light intensity. Another embodiment of a scanning system can include a single row laser diode array, and scanning mirror, which is used to perform the scanning of the entire produce. The single row scanning can provide for the introduction of a time domain as each laser completes a vertical scan. This is accomplished using a rotating polygonal mirror to scan each laser through the width of the collimating lens, and thus providing complete coverage of the produce piece.

The EMR emitter can include an LED array as a light source, in which a collimating lens array provides complete coverage of the produce with collimated light. The EMR emitter may also include a THz horn array, or sub-THz array. The emitter can be designed to provide the desired wavelength to partially penetrate the produce.

The EMR detector can be any detector that can detect the emitted EMR and attenuated EMR. The detector can include a large area charge coupled device (CCD) array as a detector array (Such as Subaru's Supreme prime focus CCD array (8×(2k×4k))).

The detector can be associated with a collimating filter that is positioned in front of the detector array. The collimating filter can absorb scattered and external light sources, allowing only the directly transmitted portion through a: polarizing filter. The collimating filter can include a collimating tunnel array. The collimating tunnel array can include a micro-machined collimating filter.

The type of produce can determine the wavelength band of the emitter. For example, a wavelength of 532 nm from a laser can illuminate an apple with distinct variations in transmission through the apple depending on structural and material differences.

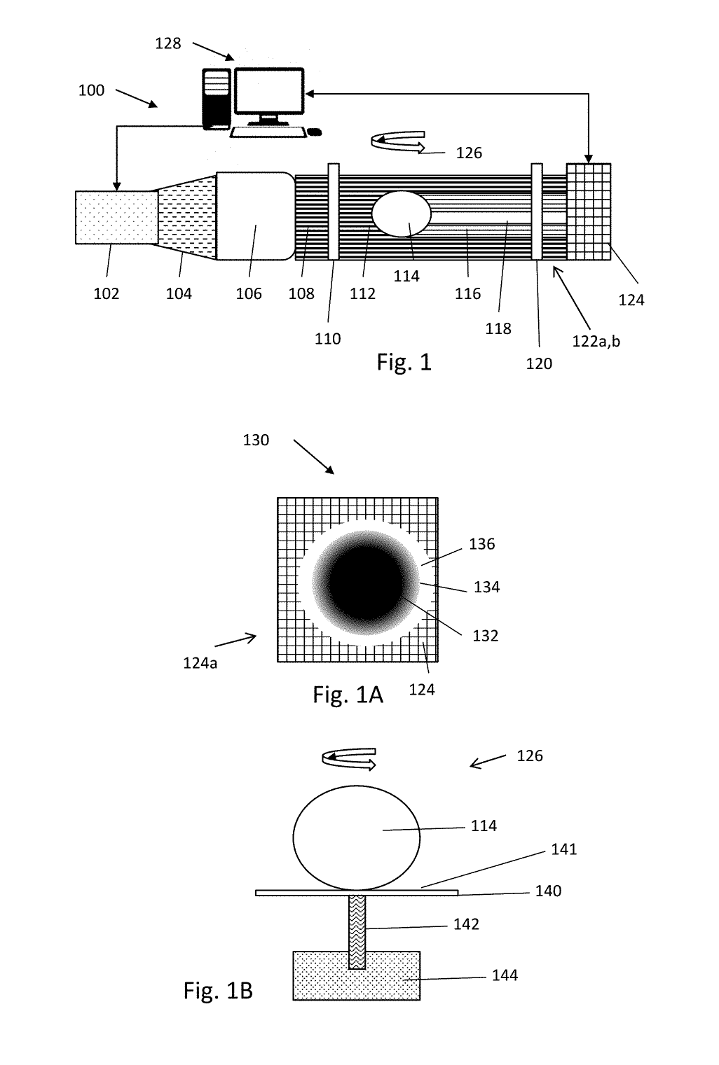

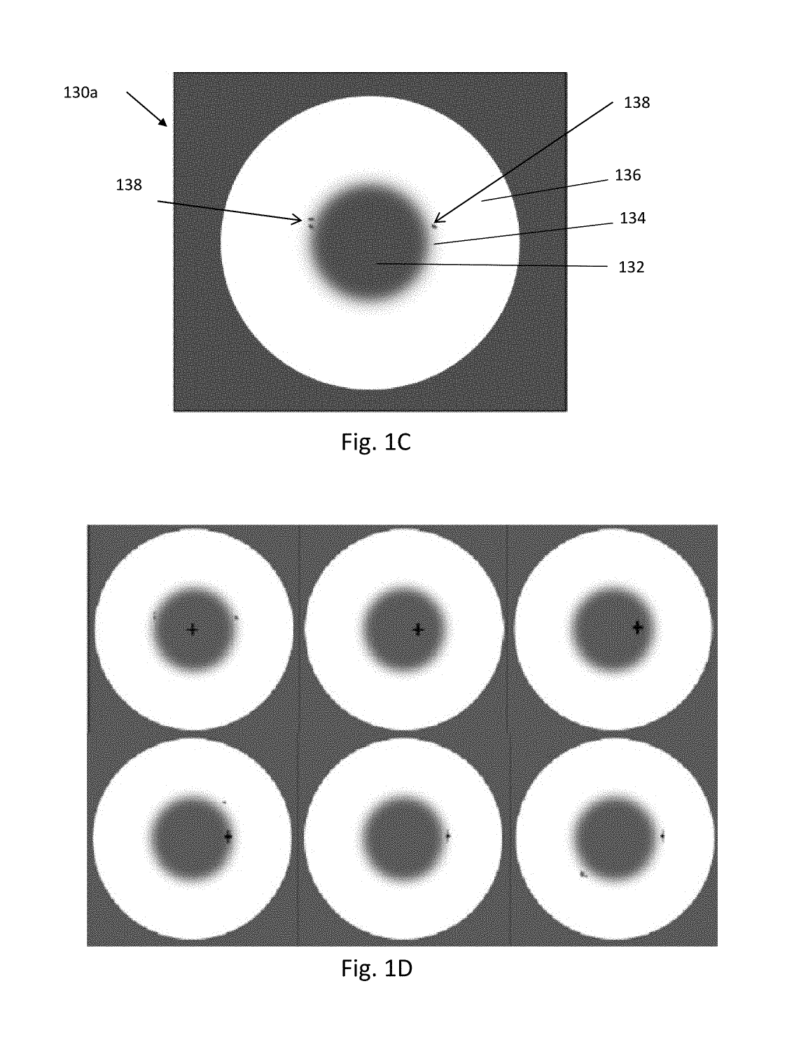

FIG. 1 illustrates an embodiment of a system 100 for scanning items 114, such as produce. The system 100 can include an electromagnetic radiation emitter 102 that emits EMR 104. The EMR 104 is directed through a collimator 106 that collimates the EMR into collimated EMR 108. The collimated EMR 108 is then directed through a polarizer 110 that polarizes the EMR to a polarized EMR 112. The polarized EMR 112 is then directed to an item 114 that is scanned by the polarized EMR 112 across the entire surface. Some EMR may pass by the item 114 without contacting the item 114 or becoming attenuated by the item 114. Some EMR passes through an outer region and through the item 114 to become attenuated EMR 116. Some EMR is blocked entirely by the item 114 and casts EMR-less region 118 on the opposite side of the item 114 from the electromagnetic radiation emitter 102. The polarized EMR 112 and attenuated EMR 116 passes through a conditioner 120 to condition the EMR into conditioned EMR 122a and conditioned attenuated EMR 122b. The conditioner 120 can be a filter, polarizer, collimator, collimating filter, collimating polarizer, or combinations thereof. The conditioner 120 may also be a separate conditioner even though only one is show, which allows for the conditioner 120 to be one or more discrete EMR conditioning devices. The conditioned EMR 122a and conditioned attenuated EMR 122b is then directed to a detector 124, which produces an image from the conditioned EMR 122a and conditioned attenuated EMR 122b. The difference in full transmittance and attenuation of the EMR compared to complete blockage can provide an image that has a core with no EMR, a ring of attenuated EMR, and a ring of fully transmitted EMR. FIG. 1A shows a representation of an image 130 obtained by the system 100, which image shows the detector 124 having the core 132 with no EMR, ring of attenuated EMR 134, and ring of fully transmitted EMR 136. This allows for inspection of the region of the item 114 that attenuates the EMR in order to detect an object that further attenuates the EMR more than the body of the item 114. The detector 124 can be a detector array 124a of a plurality of individual detectors 124. The detector array 124a of detector elements 124 is positioned so as to be operably coupled with the electromagnetic radiation emitter 102 so as to receive the emitted EMR 104.

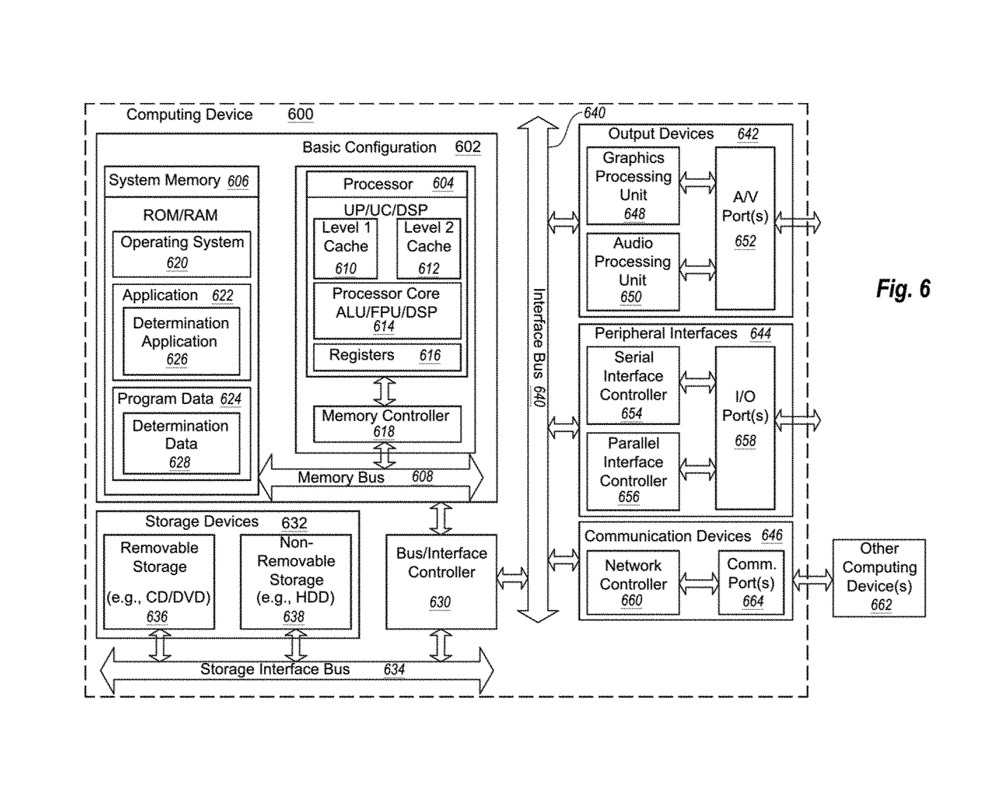

FIG. 1 also shows a computing system 128 operably coupled with the electromagnetic radiation emitter 102 and detector 124 so as to control the emission and detection of EMR. The computing system 128 can be used to perform the scanning methods described herein. FIG. 6 illustrates an example of such a computing system 128; however, improvements in computing technology may also be utilized in the computing system 128. The computing system can include software that is stored on a non-transitory medium that when ran by the computing system 128 operates the emitter 102 and detector 124 to perform the scanning methods.

FIG. 1 also shows a rotational mechanism 126 that rotates the item 114 on an axis relative to the direction of the EMR. The angle of rotation can be orthogonal or any angle relative to the direction of the EMR. FIG. 1B shows a side view of a rotational mechanism 126 that is configured to rotate the item 114. As such, the rotational mechanism 126 has a stage 140 with a stage surface 141 that is configured to hold the item 114. The stage 140 is connected to a shaft 142 that is rotated by a rotational driver 144. This allows the stage 140 to be rotated in order to rotate the item 114 that is being scanned with the system 100 of FIG. 1 or other system described herein. As such, multiple images of the item 114 can be taken so that the outer region of the item 114 that allows for some transmittance (e.g., some attenuation but not fully blocking EMR) can be imaged in substantially its entirety to determine if there are any objects in the item 114. The objects will cause further attenuation and reduction of the transmission of EMR through the item 114 and show up as dark spots in the ring of attenuated EMR 134.

FIG. 1C shows an actual image 130a having the core 132 with no EMR, ring of attenuated EMR 134, and ring of fully transmitted EMR 136. Also, the image 130a shows objects 138 in the item 114. These objects 138 are pests.

FIG. 1D shows a series of images 100b of the item 114 during rotation with the rotational mechanism 126. The black “+” in the series of images 100b shows the rotation. As can be seen, the item 114 includes a number of objects 138 in the outer region that corresponds with the ring of attenuated EMR 134. The item 114 can be produce and the objects 138 may be pests, which can indicate the produce is infested with pests. The different images show different locations for the pests. A computing system can process the images to detect dark spots or darkened regions in the partially attenuated ring.

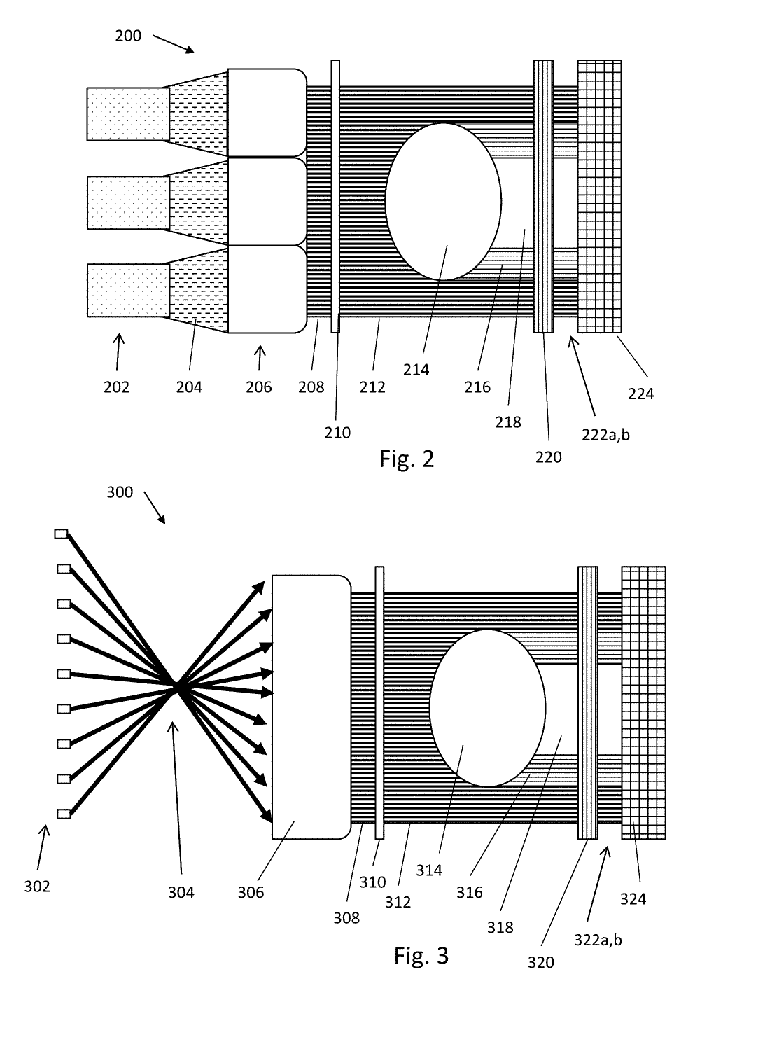

FIG. 2 illustrates an embodiment of a system 200 for scanning items 214. The system 200 can include an array of electromagnetic radiation emitters 202 that emits EMR 204. The EMR 204 is directed through an array of collimators 206 that collimates the EMR into collimated EMR 208. The collimated EMR 208 is then directed through a polarizer 210 that polarizes the EMR to a polarized EMR 212. The polarized EMR 212 is then directed to an item 214 that is scanned by the polarized EMR 212 across the entire surface. Some EMR may pass by the item 214 without contacting the item 214 or becoming attenuated by the item 214. Some EMR passes through an outer region and through the item 214 to become attenuated EMR 216. Some EMR is blocked entirely by the item 214 and casts EMR-less region 218 on the opposite side of the item 214 from the array of electromagnetic radiation emitters 202. The polarized EMR 212 and attenuated EMR 216 passes through a conditioner 220 to condition the EMR into conditioned EMR 222a and conditioned attenuated EMR 222b. The conditioned EMR 222a and conditioned attenuated EMR 222b is then directed to a detector 224, which produces an image from the conditioned EMR 222a and conditioned attenuated EMR 222b. The difference in full transmittance and attenuation of the EMR compared to complete blockage can provide an image that has a core with no EMR, a ring of attenuated EMR, and a ring of fully transmitted EMR.

FIG. 3 illustrates an embodiment of a system 300 for scanning items. The system 300 can include a converging angle array of electromagnetic radiation emitters 302 (e.g., convergent angled laser diode array) that emits EMR 304. The EMR 304 is directed through a collimator 306 or array thereof that collimates the EMR into collimated EMR 308. The collimated EMR 308 is then directed through a polarizer 310 that polarizes the EMR to a polarized EMR 312. The polarized EMR 312 is then directed to an item 314 that is scanned by the polarized EMR 312 across the entire surface. Some EMR may pass by the item 314 without contacting the item 314 or becoming attenuated by the item 314. Some EMR passes through an outer region and through the item 314 to become attenuated EMR 316. Some EMR is blocked entirely by the item 314 and casts EMR-less region 318 on the opposite side of the item 314 from the array of electromagnetic radiation emitters 302. The polarized EMR 312 and attenuated EMR 316 passes through a conditioner 320 to condition the EMR into conditioned EMR 322a and conditioned attenuated EMR 322b. The conditioned EMR 322a and conditioned attenuated EMR 322b is then directed to a detector 324, which produces an image from the conditioned EMR 322a and conditioned attenuated EMR 322b. The difference in full transmittance and attenuation of the EMR compared to complete blockage can provide an image that has a core with no EMR, a ring of attenuated EMR, and a ring of fully transmitted EMR.

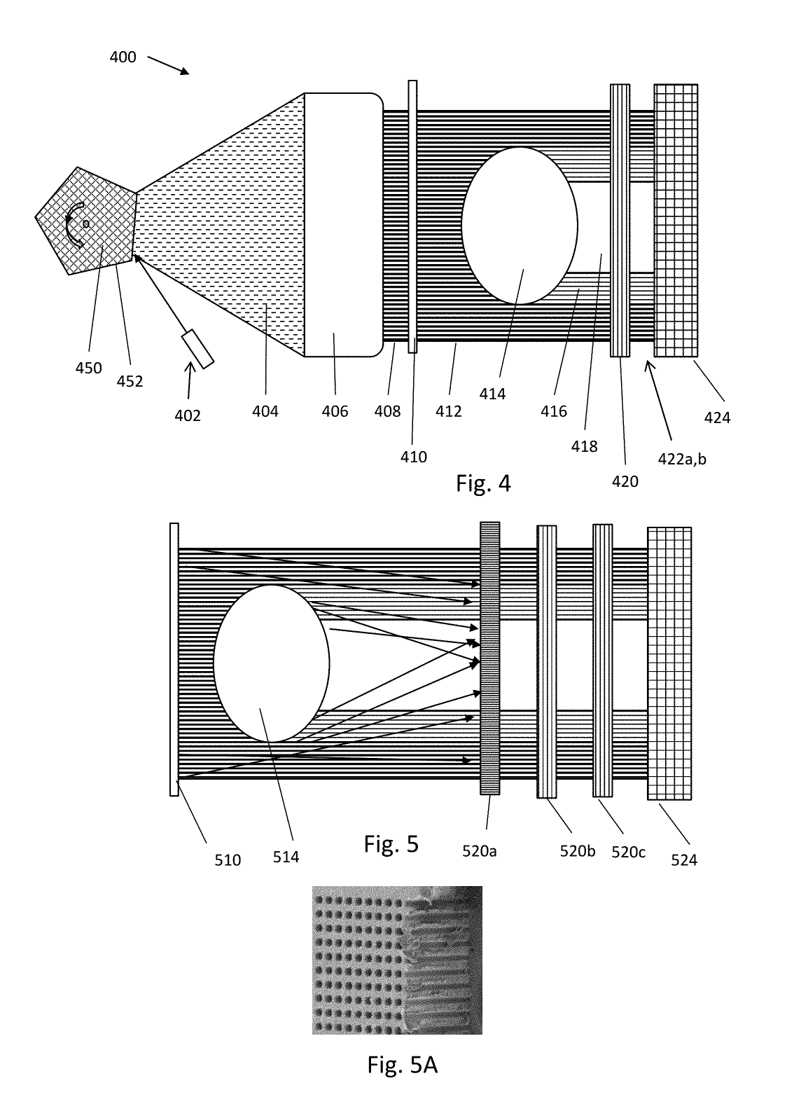

FIG. 4 illustrates an embodiment of a system 400 for scanning items. The system 400 can include one or more radiation emitters 402 (e.g., single row laser diode array or 2D laser diode array) that emits EMR 404 to a rotating polygon mirror rod 450 having a plurality of mirror faces 452 that sends a scan of EMR, shown as a fan but can be individual light beams that scan across the mirror faces 452. The EMR 304 is directed from mirror faces 452 and through a collimator 406 or array thereof that collimates the EMR into collimated EMR 408. The collimated EMR 408 is then directed through a polarizer 410 that polarizes the EMR to a polarized EMR 412. The polarized EMR 412 is then directed to an item 414 that is scanned by the polarized EMR 412 across the entire surface. Some EMR may pass by the item 414 without contacting the item 414 or becoming attenuated by the item 414. Some EMR passes through an outer region and through the item 414 to become attenuated EMR 416. Some EMR is blocked entirely by the item 414 and casts EMR-less region 418 on the opposite side of the item 414 from the array of emitters 402. The polarized EMR 412 and attenuated EMR 416 passes through a radiation conditioner 420 to condition the EMR into conditioned EMR 422a and conditioned attenuated EMR 422b. The conditioned EMR 422a and conditioned attenuated EMR 422b is then directed to a detector 424, which produces an image from the conditioned EMR 422a and conditioned attenuated EMR 422b. The difference in full transmittance and attenuation of the EMR compared to complete blockage can provide an image that has a core with no EMR, a ring of attenuated EMR, and a ring of fully transmitted EMR.

FIG. 5 illustrates an embodiment of the conditioner 520a that is configured as a collimating filter that filters light that is not directly transmitted through the item 514. That is, the EMR beams that are not along the transmitted direction, such as the EMR beams that are not parallel can be blocked by the conditioner 520a. As such, refracted or other EMR beams from the polarizer 510 that are not aligned with the conditioner 520a (e.g., collimating filter) are filtered out and do not reach the detector 524. Also shown are additional conditioners 520,b,c, which may be optional, and may be filters, polarizers, collimators, or combinations thereof. Often, a conditioner 520b can include a polarizer that is matched with the first polarizer.

FIG. 5A shows an image of an embodiment of such a collimating filter that has an array of conduits extending therethrough. If an EMR beam is not aligned with a conduit, the EMR beam is filtered and blocked. If an EMR beam is aligned with a conduit, the EMR passes through the collimating filter and is detected by the detector 524. FIG. 5 also shows the detector can include an array of individual detectors, such as a charge coupled device (CCD) array.

FIG. 6 shows an example computing device 600 that is arranged to perform any of the computing methods described herein to operate the scanning systems to perform the scanning methods.

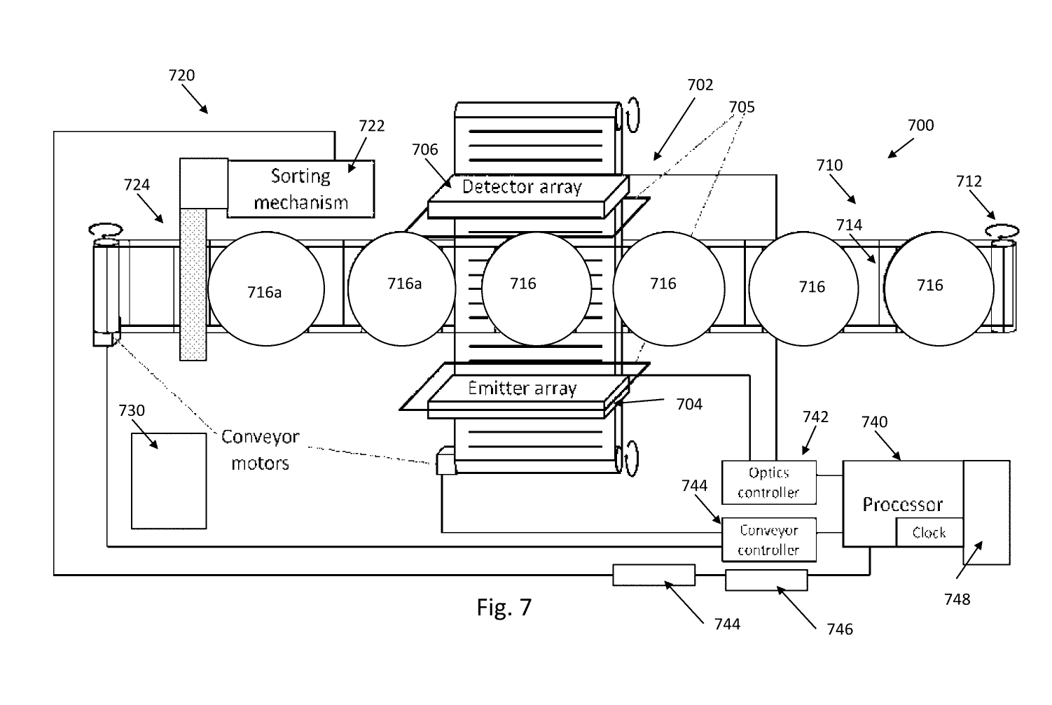

FIG. 7 shows an embodiment of a scanning and sorting system 700. The system 700 is shown to include a scanning assembly 702 that includes at least one electromagnetic radiation emitter 704, a pair of polarizing filters 705, and a detector array 706 of detector elements positioned so as to be operably coupled with the at least one electromagnetic radiation emitter 704 so as to receive the emitted electromagnetic radiation. The system 700 also includes a conveying system 710 that includes rotational mechanism 712 that rotates a conveyor belt 714. The conveying system 710 can transport the items 716 to be scanned to the scanning assembly 702. After scanning, the conveying system 710 can transport the scanned items 716a to the sorting system 720. The sorting system 720 can include a sorting mechanism 722 that can sort the scanned items 716a to select scanned items 716a to keep or select the scanned items 716a to discard. The sorting mechanism 722 may also include a separating mechanism 724 to push the selected scanned items 716a off the conveyor and onto a collector 730, where the selected scanned items 716a are either for keeping or discarding. The unselected scanned items 716a may continue on the conveying system 710 for keeping or discarding. The system 700 can also include a computing system 740 that includes a scanning assembly controller 742, a conveying system controller 744, and a sorting system controller 746, which may all be in a common computer or distributed across a network. The system 700 can also include an image processor module 748 that can process the image from the detector array 706 into a viewable image and also process the image to automatically detect dark areas in the EMR attenuated ring.

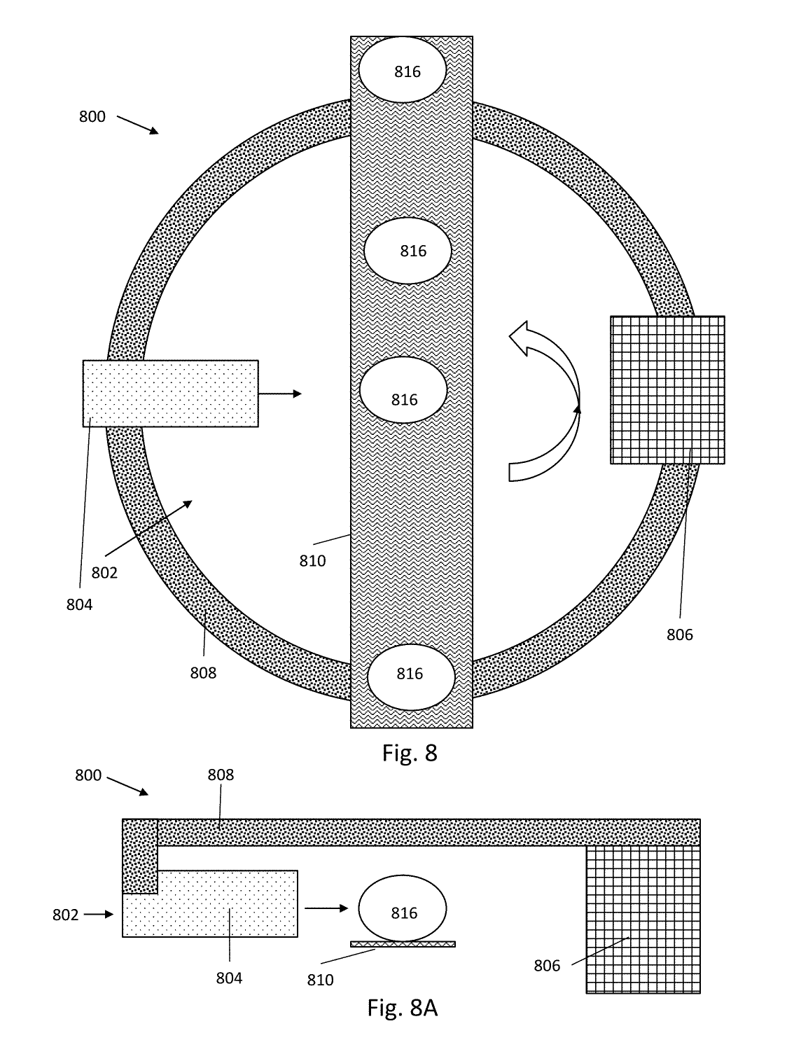

FIGS. 8 and 8A show a scanning system 800 that has the scanning assembly 802 configured to be rotatable. As such, the scanning assembly 802 can rotate around the item 816, while the item 816 is either rotating in the opposite direction or not rotating. The rotation of the scanning assembly 802 can facilitate scanning by allowing simple conveying of the item 816, such as conveying on a conveyor belt 810, water passageway, or other carrier. The scanning assembly 802 includes an emitter 804 and a detector 806, which may include the collimators, polarizers, filters, or other EMR conditioners as described herein. The emitter 804 and detector 806 can be mounted on a rotational mechanism 808 that can rotate the scanning assembly 802 around the item 816. The item 816 is shown on a conveyor belt 810. While the rotation is in the plane of the conveyor belt 810, the rotation can be orthogonal with respect to the conveyor belt 810 so that the scanning assembly 802 goes over and under the item 816, where a clear or EMR radiolucent material can be beneficial for the conveyor belt 810. However, other rotational configurations may be used.

Accordingly, the scanning system can include a scanning assembly and produce stage, and a rotational mechanism attached to at least one of the scanning assembly or produce stage such that the scanning assembly and rotational stage are rotatable with respect to each other. A first electromagnetic radiation polarizer can be operably coupled with the at least one electromagnetic radiation emitter so as to polarize the emitted electromagnetic radiation. A first electromagnetic radiation collimator can be operably coupled with the at least one electromagnetic radiation emitter so as to collimate the emitted electromagnetic radiation. While the figures show the EMR to pass through the collimator before passing through the polarizer, the system may be configured so that the EMR passes through the polarizer before being collimated. Additional filters or EMR conditions may be placed between the emitter and the produce stage.

A second electromagnetic radiation polarizer operably can be coupled with the at least one electromagnetic radiation emitter and detector array. The first and second electromagnetic radiation polarizers can be aligned along an electromagnetic radiation beam. The first and second electromagnetic radiation polarizers have the same polarization orientation. The first electromagnetic radiation polarizer is positioned between the at least one electromagnetic radiation emitter and the produce stage, and the second electromagnetic radiation polarizer is positioned between the produce stage and the detector array so as to polarize the electromagnetic radiation before being received into the detector array.

A second electromagnetic radiation collimator can be operably coupled with the at least one electromagnetic radiation emitter and detector array. The first and second electromagnetic radiation collimators can be aligned along an electromagnetic radiation beam. The first electromagnetic radiation collimator is between the at least one electromagnetic radiation emitter and produce stage, and the second electromagnetic radiation collimator is between the produce stage and the detector array so as to collimate the electromagnetic radiation before being received into the detector array.

Devices for Produce Scanning

Some embodiments disclosed herein provide devices for produce scanning, the device comprising: a light source, a produce stage, and a detector array positioned on the opposing side of the produce stage to the light source, wherein the light source and the detector array form a scanning assembly, and the transmitted light from the light source can reach the detector array.

During scanning, a portion of the light is transmitted directly through secant paths through thin sections (e.g., 3 mm in depth in the embodiment shown) of the produce, forming an imaged ring of the edge of the produce. In some embodiments, the produce may be rotated on an axis that is perpendicular to the light paths in order to acquire a series of images of the transmitted light, resulting in a full interrogation of the entire produce.

It would be appreciated that any infestation, e.g., an insect egg, of the produce in the paths of the directly transmitted light would absorb, reflect, scatter, or refract the direct transmission of such light and result in attenuation of the transmission of the light, as shown in FIG. 2. Therefore, the infestation would attenuate any directly transmitted light to reach the detector array.

Light Sources

A variety of light sources is contemplated for the produce scanning device. In some embodiments, the light source may be an EM radiation. In some embodiments, the light source may be collimated. In some embodiments, the light source is an emitter array, as illustrated in FIG. 3.

A directional EM source can include a laser array. A bed of laser diode sources can form a continuous area of coverage on the detector array. This laser array can provide a highly collimated, high power source, with high wavelength specificity. Laser diodes are low cost and available in a wide range of tuned wavelengths, particularly those in the near infrared region. Laser imaging is useful, due to the high intensity of the produced beam. Divergent laser beams are allowed to spread before being re-collimated to provide total coverage.

A scanned laser array can be used. The number of laser diodes used can be reduced substantially by use of modern laser scanning techniques. A single laser diode can cover the full distance of the detector array at its beam width with rotational mirror scanning, which allows for scanning with a single row of laser diodes. Such scanning does not reduce directionality, and lower laser density allows the use of higher power lasers while maintaining suitable power density. A single row of lasers can be used to perform the same task as the two-dimensional arrays, with the introduction of a time domain as each laser completes a vertical scan. This is accomplished using a rotating polygonal mirror to scan each laser through the width of the collimating lens, and thus the fruit piece.

A collimated LED array can be used. This array of LED light can be collimated via a lensing or a reflector structure on the LED chip, or a combination of the two. The advantages of such a system are the low cost fabrication, and broadband emission characteristics possible.

A THz or Sub-THz horn array can be used. For lower frequencies, such as those in the far-infrared and sub-terahertz regions, directional horns may be used including small scale laser horns. An array of THz or Sub-THz horns may be employed to generate complete coverage of the detector area, without a collimating lens.

A focused broadband source can be used. Multiple wavelength sources including LED combinations and laser combinations may be focused into a continuous collimated area. Broadband detector methods are used to provide a broad spectrum of wavelengths. The source can be pulsed at the detector read frame-rate to save power, and mitigate heat source heat generation as part of a thermal management scheme.

The EM radiation has a wavelength that is capable of passing through sufficient tissue distances to allow the secant path to reach a maximum depth of at least 3 mm beneath the surface of the produce. Several wavelength bands penetrate fruit and produce tissue sufficiently to enable transmission through thin sections. Some long wavelength low frequency bands are transmitted very strongly, but increasing wavelength beyond a certain point introduces intolerable imaging resolution reductions.

Some wavelength bands with good transmission properties that may be used for the light source are: 600-900 nm with peak performance around 810 nm,-8000 nm and 400-550 nm. In some embodiments, the light source may have a frequency of 37 Thz or 100-800 GHz.

When using visible light and near infrared different wavelengths and intensities may be used for different fruits depending on surface color and water content.

Exemplary EMR sources may include, but not limited to, a laser array, a scanned laser array, an LED array, a THz horn array, a Sub-THz horn array, a focused broadband source using multiple wavelength sources such as LED combinations or laser combinations, or a combination thereof. The EMR source can be a light source. In some embodiments, the laser array may be a defocused laser diode array or a convergent angled laser diode array. In some embodiments, the light source may be pulsed. For example, the light source may be pulsed at the detector read frame-rate to save power, and mitigate heat source heat generation as part of a thermal management scheme.

Preferably, the light source may be a collimated light source to eliminate noise from scattered and re-emitted light and external light. In some embodiments, a polarizing filter may be included for the light source, and a corresponding polarizing filter may be used on the detector array, so that only the transmitted light from the light source having the correct polarization may reach the detector array. In some embodiments, the light source, such as a laser diode array, may be positioned with enough distance from the collimating lens and/or the polarizing filter to allow the light beams from the light source to spread and cover the entire produce.

A scanning device can include a defocused laser diode array as the light source, a produce, and a detector array positioned on the opposing side of the produce to the light source. Divergent laser beams from the defocused laser diode array are allowed to spread before being collimated using a collimating lens array. A polarizing filter is further provided to make the collimated light source polarized as well. The laser diode array forms continuous area coverage on the detector array. This laser diode array provides a highly collimated, high intensity light source, with high wavelength specificity. Laser diodes are low cost and available in a wide range of tuned wavelengths, particularly those in the near infrared region.

A scanning device can include a convergent angled laser diode array as the light source, a produce, and a detector array positioned on the opposing side of the produce to the light source. A polarizing filter and a collimating lens are used to produce collimated and polarized light beams.

In some embodiments, laser scanning technology may be used to reduce the number of laser diodes. A scanning device can include a single row laser diode array as the light source, a produce, and a detector array positioned on the opposing side of the produce to the light source. A rotating polygon mirror is used to scan each laser through the width of the collimating lens and the produce. A polarizing filter and a collimating lens are used to produce collimated and polarized light beams.

An LED array can be used as the light source. A collimating lens array is placed between the LED array and the produce to provide collimated light to the produce. A reflector structure may also be used to produce collimated light. In addition, a polarizing filter is positioned between the light source and the produce to make the collimated light source polarized as well.

For lower frequencies such as those in the far-infrared and sub-terahertz regions, directional horns may be used including small scale laser horns as described in Wang S et al. (2003) Dielectric Properties of Fruits and Insect Pests as related to Radio Frequency and Microwave Treatments, Biosystems Engineering 85: 201-212, the content of which is hereby expressly incorporated by reference in its entirety.

Detector Array

The photoreceptive portion of the detector can be a standard high resolution CCD (Charge Coupled Device) array tuned for the wavelength band in use. For THz and sub-THz interrogation, a silicon CMOS antenna array tuned to the relevant THz frequency is used in place of a CCD for the receptive portion of the detector. (F. Schuster, D. Coquillat, W. Knap et al. Broadband terahertz imaging with highly sensitive silicon CMOS detectors. Opt. Expr. vol. 19, pp. 7827-7832, 2011.) The detector can include a tunnel collimator that can collimate and absorb light that is not aligned with the EMR beam. Any light not collimated on entry is absorbed by filters. The collimation can eliminate noise from scattered light and any light that is not directly transmitted in a linear path from the source. This allows the detector to be highly sensitive, and detect minute variations and abnormalities from the baseline transmitted light strength that arise from interaction with insect life stages. An image of the transmitted light and any shadows or distortions within it, is produced for analysis by software.

The detector may also take the form of a one-dimensional array that scans the width of the produce in the time domain. All the same collimating and filtering is applied. This reduces the size and number of elements for the CCD component.

The directly transmitted lights may be detected by a detector array. In some embodiments, the detector array may be a large area charge coupled device (CCD) array tuned for the wavelength band in use. In some embodiments, the detector array may generate an image showing the transmitted lights as different shades of gray.

An image can be formed at the detector array. Infestation of the produce is visible as dark shadows due to the attenuation of the directly transmitted light by blocking and scattering by the insect life-stages, e.g., eggs, present under the surface of the produce. In some embodiments, for example when the produce is rotated, the detector array may generate a series of images which represent a complete coverage of the subsurface region of the produce. FIG. 1D shows a series of six images generated by the detector array through a 90° rotation of the produce, i.e., one image per 15° rotation. In some embodiments, one image is generated for every 5°, 6°, 9°, 10°, 12°, 15°, 16°, 18°, 20°, 30°, 45°, or 60° rotation, or any value in between these values. In some embodiments, enough images are generated to represent a partial or complete coverage of the subsurface region of the produce.

It would be appreciated that the detector array is only reachable by lights from the light source that have been directly transmitted through the produce between the light source and the detector array. This allows the detector array to be highly sensitive, and capable of detecting minute variations and abnormalities from the baseline transmitted light strength that arise from absorption, reflection, scattering, or refraction by any infestation of the produce, such as insect life-stages. Therefore, in some embodiments, the detector array may comprise a collimating filter to prevent any scatter light or light not transmitted directly through the produce to reach the detector array. A collimating filter can be positioned in front of the detector array which absorbs any external light or scattered light. Exemplary collimating filters can include micro-machined collimating filters comprising collimating tunnels arrayed perpendicular to the detector array. In some embodiments, the detector array may further comprise a polarizing filter positioned between the produce and the detector array. Accordingly, only directly transmitted light having the original polarization of the light source may reach the detector array. The collimating tunnels have a depth:width aspect ratio that is high enough to provide sufficient collimation so that only directly transmitted light from the light source through the produce can reach the detector array. For example, the collimating tunnels may have a depth:width aspect ratio that is about at least 10:1, 20:1, 30:1, 40:1, 50:1, 100:1, or a range that is between any two of the above mentioned values. Preferably, the collimating tunnels may have a depth:width aspect ratio that is at least 50:1.

Collimator

Effective operation of the system can be achieved with collimated EMR to eliminate noise from scattered and re-emitted light and external sources to the detector. An effective method of collimation is radiation absorbent collimating tunnels that are arrayed perpendicular to the detector array. The greater the length, lower the diameter and greater the absorbance of such tunnels, the stricter the collimation. A micro-patterned grating or a micro-machined tunnel array can be formed from a highly absorbent material such as silicon black. Each detector element possesses its own tunnel, and the tunnels are most effective if they possess a depth:width aspect ratio of >50:1.

Polarizer

The system can use polarizing filters to polarize the EMR. The EMR can be polarized to a first polarization before the produce, and then can be polarized to the same first polarization after the produce and before the detector. The same polarizing filter can be used to increase the distinction between other sources of light and re-scattered light at the detector. Both the polarizing filter at the emitter and the polarizing filter at the detector are oriented the same.

This directional selectivity of the detector is reinforced by polarization selectivity, in which only light with the original source polarization is permitted to reach the detector. This is accomplished by the polarization of source light and detector incident light by identical orientation filters. Scattering alters the polarization of light, thus only directly transmitted light can pass.

Image Recognition and Analysis

The system can capture a series of images of the rotating produce. Each of the series of images of a single item of produce captured by the scanner are processed by rapid image recognition software to determine the size and transmissive boundary of the item. Distinctive shapes and distortions caused by insect life stages are then identified by edge and contrast detection. The data obtained by this image recognition is then processed separately to provide a result of either infested produce or infestation free produce. An advanced design of the software may be used to specifically identify types and stages of insect, and provide increased differentiation between fruit defects and pests.

Additionally, as the scanning device provides a precise location of a pest's presence within the item, it is possible to directly apply a targeted beam or multiple beams to that exact point to kill the pest, and sterilize the item without causing widespread damage. Such targeted beams can be by laser ablation. The produce may be edible and shippable after target pest removal by laser ablation.

Systems for Automated Produce Scanning and Sorting

Some embodiments disclosed herein provide systems for produce scanning, comprising a device comprising: a light source, a produce stage, and a detector array positioned on the opposing side of the produce stage to the light source, wherein the light source and the detector array form a scanning assembly, and the transmitted light from the light source can reach the detector array, and a rotation controller that controls the rotation of the produce stage or the scanning assembly.

An exemplary system design can include a produce scanning device integrated with a conveyor belt system. Produce is fed through step-wise at a consistent rate on a feed conveyor belt on to the produce stage of the produce scanning device. The produce comes in contact with a gripped rubber conveyor running perpendicular to the feed conveyor belt when positioned between the light source and detector array. The feed conveyor belt is halted at this point and the produce scanning device scans the produce while the produce is rotated 180° by the perpendicular conveyor. After the produce is scanned, the next produce is then brought into the produce scanning device by the feed conveyor belt. An optics controller is shown to control the light source and the detector array, for example, so that the light source may be pulsed at the detector read frame-rate to save power, and mitigate heat source heat generation as part of a thermal management scheme. The optics controller may also receive the images generated by the detector array for further analysis. A conveyor controller is shown to control the feed conveyor belt and the perpendicular conveyor. A processor is also included, which is connected to the optics controller and the conveyor controller. In addition to sending operation commands to the controllers, the processor may include an image analyzing software to process the images generated by the detector array. Based on the image analysis result, the process may identify any insect infestation of the produce, and sort the produce according to the presence of insect infestation using the sorting mechanism.

Methods for Automated Produce Scanning and Sorting

Some embodiments disclosed herein provide methods for produce scanning using a system for produce scanning disclosed herein, comprising: placing a produce on the produce stage; emitting a light on the produce using the light source to form a plurality of secant light paths through the produce; detecting the transmitted light through the plurality of secant light paths using the detector array, wherein the detector array generates a detector image of the produce. In some embodiments, the methods may comprise rotating the produce stage or the scanning assembly, wherein the detector array generates a series of detector images of the produce. In some embodiments, the produce stage or the scanning assembly is rotated for at least 45 degrees, 90 degrees, or 180 degrees. In some embodiments, the system for produce scanning comprises a device comprising: a light source, a produce stage, and a detector array positioned on the opposing side of the produce stage to the light source, wherein the light source and the detector array form a scanning assembly, and the transmitted light from the light source can reach the detector array, and a rotation controller that controls the rotation of the produce stage or the scanning assembly.

The detector image may be analyzed, for example, using a software program. In some embodiments, the detector image may be analyzed to determine the produce boundary region, which is recognizable by the signal strength of directly transmitted light. Insect infestations, represented by anomalies in the signal strength of directly transmitted light, may be identified. Anomalies in the signal strength of directly transmitted light may be due to different scattering and/or absorbance characteristics of insect life-stages, such as eggs, larvae, etc., or damages to produce tissue caused by the infestation. Significant divergence in the dielectric properties of fresh fruit and insect tissue are known, providing differences in absorbance characteristics at frequencies shorter than 1 GHz. See, e.g., Wang S et al., supra. Varied absorbance and reflectivity properties between insects and fruit tissue are also established for visible light and UV, as discussed in Shrestha B P et al. (2004) Optoelectronic determination of insect presence in fruit, Proc. SPIE 5271, Monitoring Food Safety, Agriculture, and Plant Health, 289, the content of which is hereby expressly incorporated by reference in its entirety.

In some embodiments, the light source is a polarized light source. In some embodiments, the light source is a collimated light source. In some embodiments, only the directly transmitted light from the light source can reach the detector array. In some embodiments, the device further comprises a polarizing filter between the produce stage and the detector array.

In some embodiments, the device further comprises a collimating filter between the produce stage and the detector array. In some embodiments, the collimating filter comprises radiation absorbent collimating tunnels arrayed perpendicular to the detector array. In some embodiments, the radiation absorbent collimating tunnels form a micro-patterned grating. In some embodiments, the radiation absorbent collimating tunnels form a micro-machined tunnel array. In some embodiments, the radiation absorbent collimating tunnels comprise a highly absorbent material such as silicon black. In some embodiments, each detector element of the detector array comprises a separate radiation absorbent collimating tunnel. In some embodiments, the radiation absorbent collimating tunnels comprise a depth:width ratio of at least 50:1.

In some embodiments, the light source has a wavelength band that is selected from the group consisting of 400-550 nm, 600-900 nm, and 8000 nm. In some embodiments, the light source has a frequency that is selected from the group consisting of 37 THz and 100-800 GHz. In some embodiments, the light source is selected from the group consisting of a laser array, a scanned laser array, an LED array, a THz/Sub-THz horn array, a focused broadband source, and a combination thereof.

In some embodiments, the device further comprises a polarizing filter between the light source and the produce stage. In some embodiments, the device further comprises a collimating lens between the light source and the produce stage. In some embodiments, the detector array is a charge coupled device (CCD) array. In other embodiments it may be a THz tuned silicon CMOS antenna array.

Some embodiments disclosed herein provide systems for produce scanning, comprising a device comprising: a light source, a produce stage, and a detector array positioned on the opposing side of the produce stage to the light source, wherein the light source and the detector array form a scanning assembly, and the transmitted light from the light source can reach the detector array, and a rotation controller that controls the rotation of the produce stage or the scanning assembly.

In some embodiments, the system further comprises an optics controller. In some embodiments, the optics controller controls the light source, the detector array, or the scanning assembly. In some embodiments, the system further comprises a conveyor that is connected to the produce stage or the scanning assembly. In some embodiments, the system further comprises a conveyor controller that controls the conveyor connected to the produce stage of the scanning assembly.

In some embodiments, the system further comprises a sorting mechanism that sorts the produce. In some embodiments, the system further comprises a processer that operates the optics controller, the rotation controller, the conveyer controller, the sorting mechanism, or a combination thereof.

Some embodiments disclosed herein provide methods for produce scanning, comprising: a) placing a produce on a produce stage; b) emitting a light on the produce using a light source to form a plurality of secant light paths through the produce; c) detecting the transmitted light through the plurality of secant light paths using a detector array positioned on the opposing side of the produce stage to the light source, wherein the light source and the detector array form a scanning assembly, and the transmitted light from the light source can reach the detector array; d) rotating the produce stage or the scanning assembly; and e) repeating steps c)-d) until the produce stage or the scanning assembly has been rotated for at least 180 degrees, wherein the detector array generates a series of detector images of the produce.

In some embodiments, the transmitted light through a secant light path at least 3 mm beneath the surface of the produce is detected by the detector array. In some embodiments, the produce stage or the scanning assembly is rotated substantially parallel to the plurality of secant light paths.

In some embodiments, the produce is a fruit or a vegetable. In some embodiments, the produce is primarily convex. In some embodiments, the fruit is selected from a group consisting of bananas, apricots, mangos, damsons, nectarines, peaches, apples, grapes, figs, kiwis, pears, tomatoes and plums.

In some embodiments, an insect in the plurality of secant light paths causes attenuated transmission of the light in the produce. In some embodiments, the insect in the plurality of secant light paths causes attenuated transmission of the light in the produce by differential absorption, reflection, scattering, or refraction from the direct transmission light path. In some embodiments, the light is a polarized and collimated light.

In some embodiments, the method further comprises analyzing the series of detector images of the produce. In some embodiments, the series of detector images of the produce is analyzed using a software program. In some embodiments, analyzing the series of detector images of the produce indicates presence or amount of insect infestation in the produce. In some embodiments, the presence or amount of insect infestation in the produce comprises one or more life stages, e.g., an egg, a larva, etc., of the insect.

In some embodiments, the method further comprises sorting the produce according to the presence or amount of insect infestation in the produce. In some embodiments, analyzing the series of detector images of the produce identifies a location of insect infestation in the produce. In some embodiments, the method further comprises sterilizing the produce based on the location of insect infestation in the produce.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular embodiments only, and is not intended to be limiting.

In one embodiment, the present methods can include aspects performed on a computing system. As such, the computing system can include a memory device that has the computer-executable instructions for performing the method. The computer-executable instructions can be part of a computer program product that includes one or more algorithms for performing any of the methods of any of the claims.

In one embodiment, any of the operations, processes, methods, or steps described herein can be implemented as computer-readable instructions stored on a computer-readable medium. The computer-readable instructions can be executed by a processor of a wide range of computing systems from desktop computing systems, portable computing systems, tablet computing systems, hand-held computing systems as well as network elements, and/or any other computing device. The computer readable medium is not transitory. The computer readable medium is a physical medium having the computer-readable instructions stored therein so as to be physically readable from the physical medium by the computer.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive, a CD, a DVD, a digital tape, a computer memory, any other physical medium that is not transitory or a transmission. Examples of physical media having computer-readable instructions omit transitory or transmission type media such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

FIG. 6 shows an example computing device 600 that is arranged to perform any of the computing methods described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof. Processor 604 may include one more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations memory controller 618 may be an internal part of processor 604.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624. Application 622 may include a determination application 626 that is arranged to perform the functions as described herein including those described with respect to methods described herein. Program Data 624 may include determination information 628 that may be useful for analyzing the contamination characteristics provided by the sensor unit 240. In some embodiments, application 622 may be arranged to operate with program data 624 on operating system 620 such that the work performed by untrusted computing nodes can be verified as described herein. This described basic configuration 602 is illustrated in FIG. 6 by those components within the inner dashed line.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety.

1. A system for scanning produce, the system comprising:
a scanning assembly comprising:
at least one electromagnetic radiation emitter; and
a detector array of detector elements positioned so as to be operably coupled with the at least one electromagnetic radiation emitter so as to receive the emitted electromagnetic radiation;
a produce stage; and
a rotational mechanism attached to at least one of the scanning assembly or produce stage such that the scanning assembly and rotational stage are rotatable with respect to each other.

2. The system of claim 1, further comprising a first electromagnetic radiation polarizer operably coupled with the at least one electromagnetic radiation emitter so as to polarize the emitted electromagnetic radiation.

3. The system of claim 2, further comprising a first electromagnetic radiation collimator operably coupled with the at least one electromagnetic radiation emitter so as to collimate the emitted electromagnetic radiation.

4. The system of claim 2, further comprising a second electromagnetic radiation polarizer operably coupled with the at least one electromagnetic radiation emitter and detector array, the first and second electromagnetic radiation polarizers being aligned along an electromagnetic radiation beam, the first and second electromagnetic radiation polarizers having the same polarization orientation, wherein the first electromagnetic radiation polarizer is positioned between the at least one electromagnetic radiation emitter and the produce stage and the second electromagnetic radiation polarizer is positioned between the produce stage and the detector array so as to polarize the electromagnetic radiation before being received into the detector array.

5. The system of claim 3, further comprising a second electromagnetic radiation collimator operably coupled with the at least one electromagnetic radiation emitter and detector array, the first and second electromagnetic radiation collimators being aligned along the electromagnetic radiation beam, wherein the first electromagnetic radiation collimator is between the at least one electromagnetic radiation emitter and produce stage and the second electromagnetic radiation collimator is between the produce stage and the detector array so as to collimate the electromagnetic radiation before being received into the detector array.

6. The system of claim 5, wherein at least one of the first electromagnetic radiation collimator or second electromagnetic radiation collimator comprises an array of collimating tunnels.

7. The system of claim 6, wherein each detector element of the detector array is aligned in the electromagnetic radiation beam with a separate collimating tunnel of the array of collimating tunnels of the second electromagnetic radiation collimator.

8. The system of claim 1, wherein the electromagnetic radiation emitter has an emission wavelength band selected from the group consisting of about 400 to 550 nm, about 600 to 900 nm, about 8000 nm (e.g., 37 THz), or about 3000 microns (e.g., 100 GHz) to 374,740 microns (e.g., 800 GHz).

9. The system of claim 1, wherein the at least one electromagnetic radiation emitter is selected from the group consisting of a laser array, a scanned laser array, an LED array, a THz emitter array, a sub-THz emitter array, a far-infrared emitter array, a focused broadband source having a plurality of emitters of different wavelengths, and a combination thereof.

10. The system of claim 1, wherein the detector array includes a charge coupled device (CCD) array or a THz tuned silicon CMOS antenna array.

11. The system of claim 1, wherein the at least one electromagnetic radiation emitter includes at least one light emitter, the system further comprising one of:
a single collimating lens optically coupled with the light emitter and detector array; or
a collimating lens array optically coupled with a light emitter array and detector array.

12. The system of claim 1, comprising a rotating polygon mirror member having a plurality of mirror faces that optically couple the at least one electromagnetic radiation emitter and the detector array by reflecting electromagnetic radiation from the at least one electromagnetic radiation emitter to the detector array.

13. The system of claim 1, comprising an imaging controller operably coupled with the at least one electromagnetic radiation emitter and/or detector array to provide control thereof.

14. The system of claim 1, further comprising:
a conveyor associated with the produce stage so as to be capable of conveying produce to the produce stage; and
a conveyor controller operably coupled with the conveyer so as to be capable of controlling the conveying of produce to and/or from the produce stage.

15. The system of claim 14, further comprising:
a produce sorter associated with the conveyor so as to be capable of sorting the produce on the conveyor; and
a sorter controller operably coupled with the produce sorter as to be capable of controlling the sorting of the produce.

16. The system of claim 1, further comprising an image processor module configured for processing images obtained from the detector array.

17. A method for scanning produce, the method comprising:
transmitting electromagnetic radiation through at least a portion of a produce using at least one electromagnetic radiation emitter;
detecting the electromagnetic radiation transmitted through the at least a portion of the produce using a detector array that is operably coupled with the at least one electromagnetic radiation emitter;
rotating the produce relative to the detector array; and
imaging the produce during the rotating to obtain a series of produce images from different rotational positions.

18. The method of claim 17, further comprising analyzing the series of detector images of the produce to determine whether a pest is in the produce.

19. The method of claim 18, further comprising sorting the produce based on whether or not a pest is in the produce.

20. A method for scanning produce, the method comprising:
transmitting electromagnetic radiation through at least a portion of a produce using at least one electromagnetic radiation emitter;
detecting the electromagnetic radiation transmitted through the at least a portion of the produce using a detector array that is operably coupled with the at least one electromagnetic radiation emitter;
rotating a scanning assembly relative to the produce, the scanning assembly having the at least one electromagnetic radiation emitter and detector array; and
imaging the produce during the rotating to obtain a series of produce images from different rotational positions.

21. The method of claim 20, further comprising analyzing the series of detector images of the produce to determine whether a pest is in the produce.

22. The method of claim 21, further comprising sorting the produce based on whether or not a pest is in the produce.
